(19) United States
(12) Patent Application Publication
(10) Pub. No.: US 2014/0184410 A1
(43) Pub. Date: Jul. 3, 2014

(54) FIRE ALARM APPARATUS AND METHOD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: WEN-KAO FENG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/050,558

(22) Filed: Oct. 10, 2013

(30) Foreign Application Priority Data
Dec. 29, 2012 (CN) 2012105891111

(51) Int. Cl. G08B 17/00

(52) U.S. Cl. CPC G08B 17/00
USPC 340/540

(57) ABSTRACT

A fire alarm apparatus includes a fire detection sensor, an alarm signal generator, and an isolation circuit. The isolation circuit isolates the fire detection sensor from the alarm signal generator. When the fire detection sensor detects an occurrence of fire, the fire detection sensor transmits a voltage signal to the isolation circuit. The isolation circuit transmits a trigger signal to the alarm signal generator in response to receiving the voltage signal. The alarm signal generator generates a fire alarm signal in response to receiving the trigger signal. A fire alarm method is also provided.

### REFERENCE TO RELATED APPLICATIONS

This application claims all benefits accruing under 35 U.S.C. §119 from China Patent Application No. 201210589111.1, filed on Dec. 29, 2012 in the State Intellectual Property Office of China. The contents of the China Application are hereby incorporated by reference.

### BACKGROUND

1. Technical Field

The disclosure generally relates to fire alarm apparatuses and methods, and particularly relates to fire alarm apparatuses and methods that have anti jamming capabilities.

2. Description of Related Art

Fire alarm systems are designed to detect fire hazards by monitoring environmental changes associated with combustion. The fire alarm systems may notify the building occupants to evacuate when there is a fire, report the fire to an off-premises location to summon emergency services, and prepare the structure and associated systems to control the spread of fire and smoke. However, the conventional fire alarm systems do not have sufficient anti jamming capabilities.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of one embodiment of a fire alarm apparatus.

FIG. 2 is a block diagram of an isolating circuit of the fire alarm apparatus of FIG. 1.

FIG. 3 is a flowchart of one embodiment of a fire alarm method.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

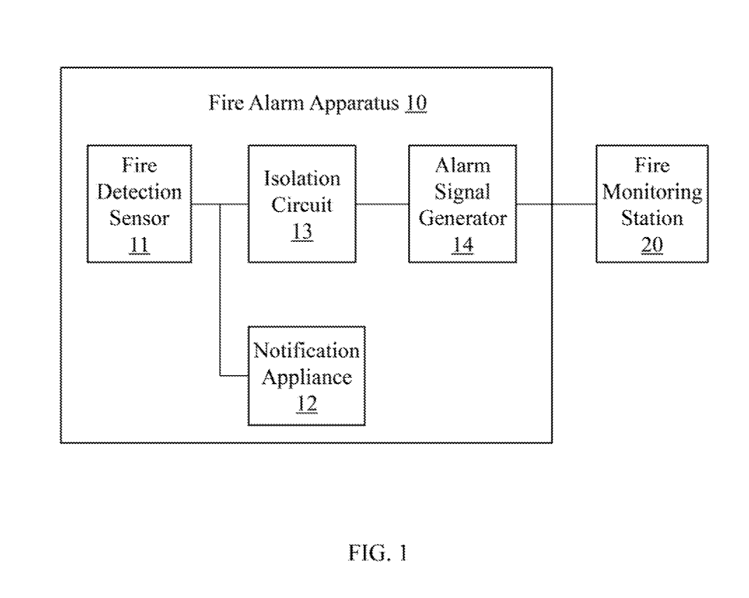

FIG. 1 shows one embodiment of a fire alarm apparatus 10. The fire alarm apparatus 10 includes a fire detection sensor 11, a notification appliance 12, an isolation circuit 13, and an alarm signal generator 14.

The fire detection sensor 11 determines an occurrence of fire by detecting heat, smoke, gas, light of flame and the like generated by a fire. When the fire detection sensor 11 detects an occurrence of fire, the fire detection sensor 11 transmits a voltage signal to the notification appliance 12 and the isolation circuit 13.

When the notification appliance 12 receives the voltage signal from the fire detection sensor 11, the notification appliance 12 makes a public announcement of the fire to inform the proximate persons of the need to take action, for example, to evacuate. In one embodiment, the notification appliance 12 may include a strobe light which flashes light when the notification appliance 12 receives the voltage signal from the fire detection sensor 11. In some other embodiments, the notification appliance 12 may include a speaker which produces sounds when the notification appliance 12 receives the voltage signal from the fire detection sensor 11.

The isolation circuit 13 isolates the fire detection sensor 11 from the alarm signal generator 14. When the isolation circuit 13 receives the voltage signal from the fire detection sensor 11, the isolation circuit 13 transmits a trigger signal to the alarm signal generator 14.

When the alarm signal generator 14 receives the trigger signal from the isolation circuit 13, the alarm signal generator 14 generates a fire alarm signal. In some embodiments, the alarm signal generator 14 transmits the fire alarm signal to a remotely located monitoring station 20 via an Internet Protocol (IP) network.

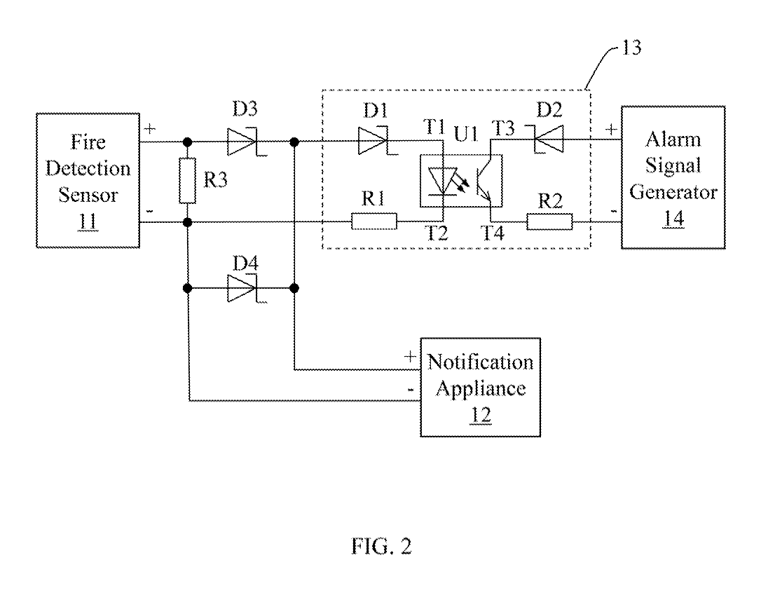

FIG. 2 shows one embodiment of the isolation circuit 13. The isolation circuit 13 includes an optical coupler U1, voltage stabilizing diodes D1 and D2, and resistors R1 and R2. The fire alarm apparatus 10 further includes a resistor R3 and voltage stabilizing diodes D3 and D4.

An anode of the voltage stabilizing diode D1 is connected to a positive output terminal of the fire detection sensor 11. A cathode of the voltage stabilizing diode D1 is connected to a positive input terminal T1 of the optical coupler U1.

An anode of the voltage stabilizing diode D2 is connected to a positive input terminal of the alarm signal generator 14. A cathode of the voltage stabilizing diode D2 is connected to a positive output terminal T3 of the optical coupler U1.

An anode of the voltage stabilizing diode D3 is connected to the positive output terminal of the fire detection sensor 11. A cathode of the voltage stabilizing diode D3 is connected to the anode of the voltage stabilizing diode D1.

An anode of the voltage stabilizing diode D4 is connected to a negative input terminal of the notification appliance 12. A cathode of the voltage stabilizing diode D4 is connected to a positive input terminal of the notification appliance 12.

An end of the resistor R1 is connected to a negative input terminal T2 of the optical coupler U1. Another end of the resistor R1 is connected to a negative output terminal of the fire detection sensor 11.

An end of the resistor R2 is connected to a negative output terminal T4 of the optical coupler U1. Another end of the resistor R2 is connected to a negative input terminal of the alarm signal generator 14.

An end of the resistor R3 is connected to the positive output terminal of the fire detection sensor 11. Another end of the resistor R3 is connected to a negative output terminal of the fire detection sensor 11.

When the positive input terminal T1 of the optical coupler U1 receives the voltage signal from the fire detection sensor 11, the negative output terminal T4 of the optical coupler U1 outputs a continuity signal to the alarm signal generator 14. The alarm signal generator 14 recognizes the continuity signal as the trigger signal.

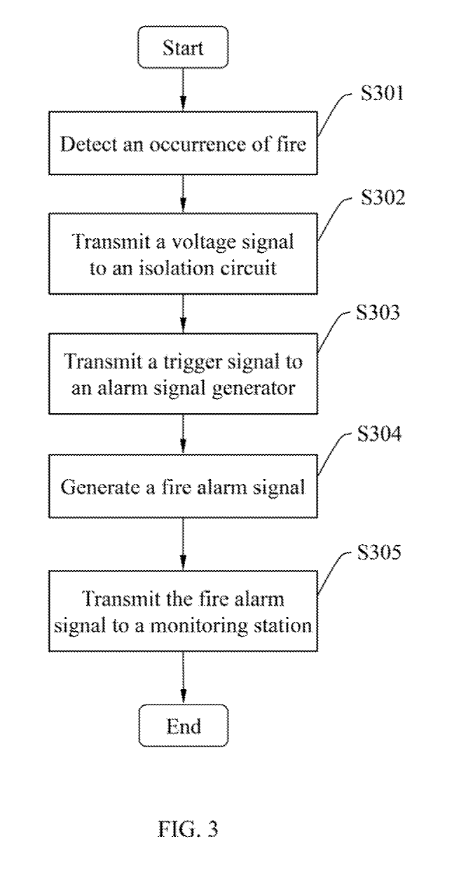

FIG. 3 shows a flowchart of one embodiment of a fire alarm method. The method includes the following steps.

In step S301, the fire detection sensor 11 detects an occurrence of fire.

In step S302, when the fire detection sensor 11 detects an occurrence of fire, the fire detection sensor 11 transmits a voltage signal to the notification appliance 12 and the isolation circuit 13.

In step S303, when the isolation circuit 13 receives the voltage signal from the fire detection sensor 11, the isolation circuit 13 transmits a trigger signal to the alarm signal generator 14. When the notification appliance 12 receives the voltage signal from the fire detection sensor 11, the notification appliance 12 informs the proximate persons of the occurrence of fire.

In step S304, when the alarm signal generator 14 receives the trigger signal from the isolation circuit 13, the alarm signal generator 14 generates a fire alarm signal.

In step S305, the alarm signal generator 14 transmits the fire alarm signal to the remotely located monitoring station 20 via an IP network.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

What is claimed is:

1. A fire alarm apparatus, comprising:
a fire detection sensor configured to detect an occurrence of fire;
an alarm signal generator configured to generate a fire alarm signal when the occurrence of fire is detected by the fire detection sensor; and
an isolation circuit configured to isolate the fire detection sensor from the alarm signal generator;
wherein the fire detection sensor is configured to transmit a voltage signal to the isolation circuit when the occurrence of fire is detected, the isolation circuit is configured to transmit a trigger signal to the alarm signal generator in response to receiving the voltage signal, the alarm signal generator is configured to generate the fire alarm signal in response to receiving the trigger signal.

2. The fire alarm apparatus of claim 1, wherein the isolation circuit comprises an optical coupler, an input terminal of the optical coupler is connected to the fire detection sensor, and an output terminal of the optical coupler is connected to the alarm signal generator.

3. The fire alarm apparatus of claim 2, wherein when the input terminal of the optical coupler receives the voltage signal from the fire detection sensor, the output terminal of the optical coupler outputs a continuity signal to the alarm signal generator, and the alarm signal generator is configured to recognize the continuity signal as the trigger signal.

4. The fire alarm apparatus of claim 3, further comprising a first voltage stabilizing diode, wherein an anode of the first voltage stabilizing diode is connected to a positive output terminal of the fire detection sensor, a cathode of the first voltage stabilizing diode is connected to a positive input terminal of the optical coupler.

5. The fire alarm apparatus of claim 4, further comprising a second voltage stabilizing diode, wherein an anode of the second voltage stabilizing diode is connected to a positive input terminal of the alarm signal generator, a cathode of the second voltage stabilizing diode is connected to a positive output terminal of the optical coupler.

6. The fire alarm apparatus of claim 5, further comprising a third voltage stabilizing diode, wherein an anode of the third voltage stabilizing diode is connected to the positive output terminal of the fire detection sensor, a cathode of the third voltage stabilizing diode is connected to the anode of the first voltage stabilizing diode.

7. The fire alarm apparatus of claim 6, further comprising a first resistor, an end of the first resistor is connected to a negative input terminal of the optical coupler, and another end of the first resistor is connected to a negative output terminal of the fire detection sensor.

8. The fire alarm apparatus of claim 7, further comprising a second resistor, an end of the second resistor is connected to a negative output terminal of the optical coupler, and another end of the second resistor is connected to a negative input terminal of the alarm signal generator.

9. The fire alarm apparatus of claim 8, further comprising a third resistor, an end of the third resistor is connected to the positive output terminal of the fire detection sensor, and another end of the third resistor is connected to a negative output terminal of the fire detection sensor.

10. The fire alarm apparatus of claim 1, wherein the alarm signal generator is further configured to transmit the fire alarm signal to a remotely located monitoring station via an Internet Protocol (IP) network.

11. The fire alarm apparatus of claim 1, further comprising a notification appliance connected to the fire detection sensor, wherein the fire detection sensor is further configured to transmit the voltage signal to the notification appliance when the occurrence of fire is detected, and the notification appliance is configured to make a public announcement of the fire.

12. The fire alarm apparatus of claim 11, wherein the notification appliance comprises a speaker configured to produce sounds when the notification appliance receives the voltage signal from the fire detection sensor.

13. The fire alarm apparatus of claim 11, wherein the notification appliance comprises a strobe light configured to flash light when the notification appliance receives the voltage signal from the fire detection sensor.

14. A fire alarm method, comprising:
detecting an occurrence of fire by a fire detection sensor;
transmitting a voltage signal to an isolation circuit by the fire detection sensor when the fire detection sensor detects the occurrence of fire;
transmitting a trigger signal to an alarm signal generator by the isolation circuit when the isolation circuit receives the voltage signal from the fire detection sensor; and
generating a fire alarm signal by the alarm signal generator when the alarm signal generator receives the trigger signal from the isolation circuit.

15. The fire alarm method of claim 14, wherein the isolation circuit comprises an optical coupler, when an input terminal of the optical coupler receives the voltage signal from the fire detection sensor, an output terminal of the optical coupler outputs a continuity signal to the alarm signal generator, and the alarm signal generator is configured to recognize the continuity signal as the trigger signal.

16. The fire alarm method of claim 14, further comprising transmitting the fire alarm signal to a remotely located monitoring station via an Internet Protocol (IP) network by the alarm signal generator.

17. The fire alarm method of claim 14, further comprising:
transmitting the voltage signal to a notification appliance by the fire detection sensor when the occurrence of fire is detected; and
making a public announcement of the fire by the notification appliance when the notification appliance receives the voltage signal from the fire detection sensor.

18. The fire alarm method of claim 17, wherein the notification appliance comprises a speaker, the speaker produces sounds when the notification appliance receives the voltage signal from the fire detection sensor.

19. The fire alarm method of claim 17, wherein the notification appliance comprises a strobe light, the strobe light flashes light when the notification appliance receives the voltage signal from the fire detection sensor.
